(19) United States
(12) Patent Application Publication
(10) Pub. No.: US 2014/0345185 A1
(43) Pub. Date: Nov. 27, 2014

(54) REUSABLE FLEXIBLE FISHING LURE

(71) Applicants: Tanguy MARLIN, EYSINES (FR); Franck ROSMANN, SAINT MEDARD EN JALLES (FR)

(72) Inventors: Tanguy MARLIN, EYSINES (FR); Franck ROSMANN, SAINT MEDARD EN JALLES (FR)

(73) Assignee: SERT, BLANQUEFORT (FR)

(21) Appl. No.: 14/285,748

(22) Filed: May 23, 2014

(30) Foreign Application Priority Data
May 23, 2013 (FR) 13 54652

(51) Int. Cl. A01K 85/18; A01K 85/16

(52) U.S. Cl. CPC A01K 85/18; A01K 85/16
USPC 43/42.24

(57) ABSTRACT

A reusable flexible fishing lure (10), including a head (12), a body (14), and a tail (16), is characterized in that it includes at least one cut-out (18) forming a rupture initiator (20), at right angles to the junction of the head (12) and the body (14). The lure can thus be used as such or with a lead-sealed head to replace the cut-out head.

### FIELD OF THE INVENTION

This invention relates to a flexible fishing lure.

### BACKGROUND OF THE INVENTION

Fishing with natural bait is complex because it requires obtaining said natural bait.

Fishing with lures that are imitations of fish likely to constitute prey has been developed.

These lures are of different types and are used in fresh water as well as in salt water, and even brackish water.

There are at least two large categories: rigid lures and flexible lures.

The lures have particular applications and particular structures that are not addressed here because they are not advantageous to this invention.

The flexible lures are generally imitations of prey, invertebrates or small fish, and it is these lures that are addressed by this invention.

### SUMMARY OF THE INVENTION

The flexible lure comprises a head, a body, and a tail.

The fish is generally equipped with a tail whose profile varies depending on the swimming required to make it perform and the desired effect during its movement. The profile of the tail actually makes it possible to vary the jerking, therefore the vibrations, and therefore the attractiveness based on the fishing method and the species sought.

As for the head, it has a profile that is adapted to that of the desired use, and primarily it is the closest imitation of the natural fish that the lure seeks to imitate.

The materials of which the lures consist have made very significant progress, making it possible to attain almost the consistency of the natural fish that they are meant to imitate.

The color and the decoration are also produced in the material and/or painted on the surface, with the most realistic or the most attractive nuances and representations possible, in particular from the standpoint of reflections.

The flexible lures are used for the most part in combination with a fitting. Only certain attraction lures, “teasers,” making it possible to sensitize the fish to make him grasp a larger or different prey, placed downstream from said teasers, may not have fittings.

A generally simple hook is defined as a fitting. This hook is inserted through the mouth of the fish and protrudes through the stomach or through the back according to the technique. A channel can even be made in the body to ensure a certain guiding, and the outlet opening is already preformed so that its flanges have a better mechanical resistance, in particular to tearing.

Only the tip and the barb and a small portion of the curved part of the shaft protrude, with the shaft remaining, to a very large extent, hidden inside the body of the fish.

The free end of the shaft bears the attachment means to a fishing leader; in general, these attachment means comprise a ring.

In this case, the proposed lure is an integral head-body-tail unit.

The fish is therefore shown on the fitting, and the traction is performed on said fitting, with the lure joining said fitting but not being mechanically stressed except by the traction that said fitting generates on the body. It is noted that the body abuts the bottom of the curved part of the shaft.

There are also other fittings such as the lead-sealed heads. These fittings make it possible to add the desired weight to the lure based on fishing conditions and fishing techniques used, the force of the current, the wind, and the working depth, for example.

A first type of lead-sealed head consists of a hook intended to be mounted as above except that the shaft projects to a large extent and carries a metal material at its free projecting end, often made of lead. This material takes the shape of a ball for the simplest ones. The metal material is then located in front of the head and more specifically in front of the mouth of the fish. Here again, the fish is integral with a head-body-tail unit.

A second type of lead-sealed head consists of a metal material in the shape of a fish head, more particularly in the shape of the most suitable fish head relative to the species involved for the imitation.

The lead-sealed head always comprises a hook, integral with said head, in particular embedded in the cast lead when the head is made of lead. This hook is mounted through the body of the fish as above.

In some cases, as a variant, the shaft of the hook is articulated behind the metal material, which makes possible a degree of liberty between the metal material that constitutes the lead-sealed head and the shaft arranged in the body of the lure.

The difference in the case of this lead-sealed head in the shape of a fish head is that the lead-sealed head in the shape of a fish head, which may or may not be articulated, replaces the head of the fish that constitutes the lure.

For this purpose, there are flexible lures that come in the form of a body-tail unit only, without a head, suitable for receiving the lead-sealed heads.

These body-tails generally come in a pouch or blister but their presentation is not very attractive for the buyer.

In addition, it is understood that for a fisherman who desires to use entire flexible lures or only flexible lure bodies with lead-sealed heads, it is necessary to use two types of flexible lures.

The object of this invention is a flexible lure, suitable for being used as an integral unit or only as a body/tail of a flexible lure, in a fitting with a lead-sealed head.

### BRIEF DESCRIPTION OF THE DRAWINGS

The invention is now described in detail, according to a particular non-limiting embodiment, relative to the accompanying drawings that show:

FIG. 1: A lure according to the invention, perspective view,

FIG. 2: The lure of FIG. 1, left lateral elevation view,

FIG. 3: The lure of FIG. 1, bottom view,

FIG. 4: The lure of FIG. 1, top view,

FIG. 5: The lure of FIG. 1, armed with a simple hook,

FIG. 6: The lure of FIGS. 1 to 5, once the head is removed,

FIG. 7: The lure of FIG. 6, armed with a lead-sealed head in the shape of a fish head.

### DETAILED DESCRIPTION OF THE INVENTION

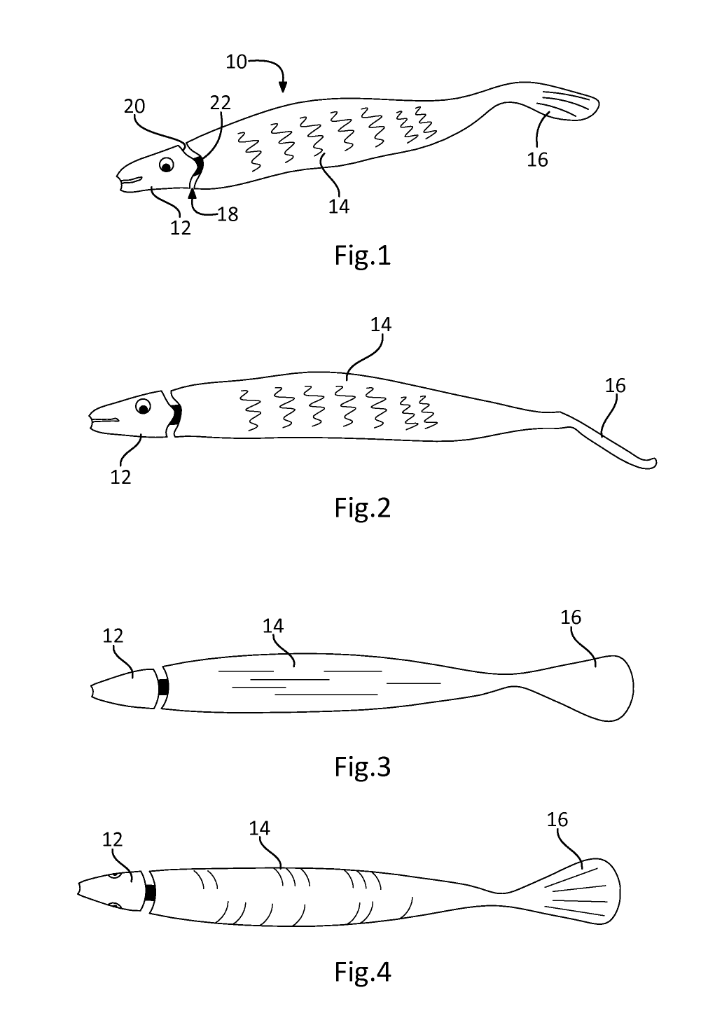

In FIGS. 1 to 5, the lure 10 comprises a head 12, a body 14, and a tail 16.

The lure 10 is made of a flexible material, of elastomer.

At least one cut-out 18 that forms a rupture initiator 20 is also provided.

This at least one cut-out 18 is provided at right angles to the junction of the head 12 and the body 14, essentially at the level of what would correspond to the gills of a true fish and in this case the gills of its representation that constitutes the lure 10.

In the embodiment according to the invention, the cut-out 18 is unique and peripheral.

The cut-out 18 extends downward over a portion of the volume of the body, leaving at least one connecting bridge 22 between the head 12 and the body 14. The connecting bridge 22 is adequate for maintaining a mechanical connection between the head and the body.

The cut-out 18 can be simply a peripheral ring, made in the same plane.

Nevertheless, and in a preferred approach, the cut-out 18 can be along a particular profile that is on the front for the parts located above and below the lure and set back on the lateral surfaces corresponding to the gills as when the removal of the head of a natural fish is initiated. Thus, the cut-out is anatomical.

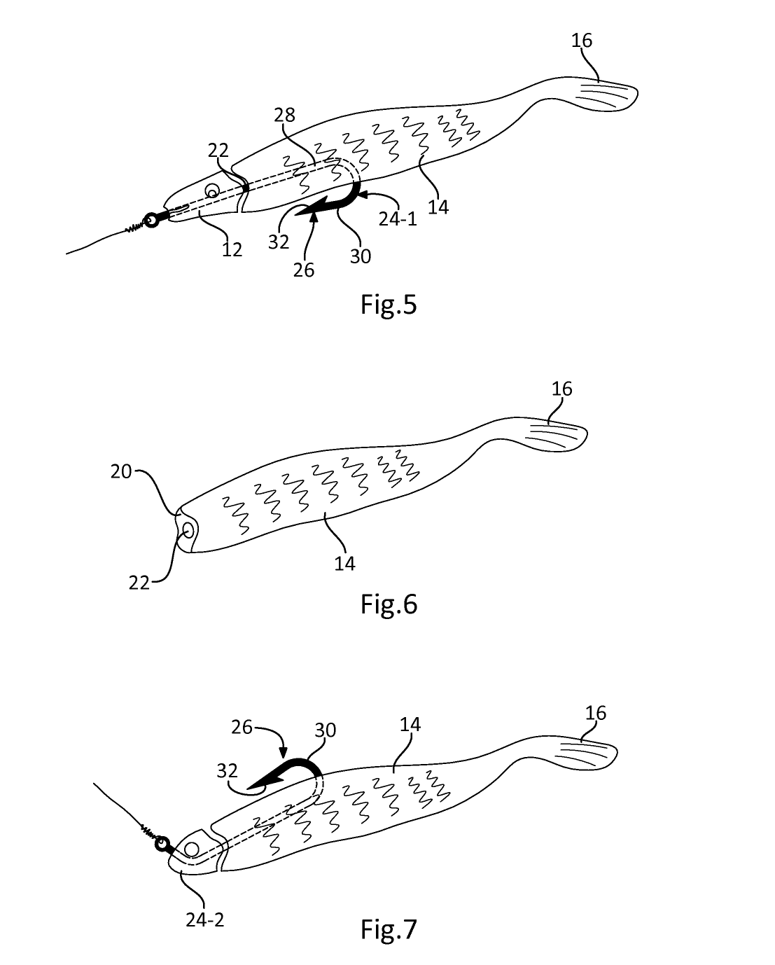

The lure 10 according to the invention, thus constituted, can be used as a monolithic lure. This lure can thus receive a fitting 24-1 in the shape of a hook 26 whose shaft 28 is located along the longitudinal axis of the body, and the tip 30 and the barb 32 of said hook project above and/or below the body 14. This arrangement is shown in FIG. 5.

Thus, such a lure can be mounted on a dragnet fishing line, by itself or more generally on a drifting fishing leader, upstream from an end lure, rigid lure, articulated, spoon, or natural lure.

If the fisherman-user finds that he has to change fishing technique and that it is better to fish adrift, for example aboard a boat, by jerking the lure, or by casting/reeling in, a lure with a lead-sealed head, i.e., a fitting 24-2 with a lead-sealed head, is needed.

Consequently, the weight of the lure and therefore its ballasting are essential based on the current, the drifting speed, to reach the bottom with the lure or to stay at least close to the bottom or quite simply at the desired casting distance.

In this case, either the fisherman uses lures upstream that are mounted as for drifting, i.e., adrift with a fitting and upstream, therefore above the final lure with lead-sealed head, or the fisherman uses a flexible lure with a lead-sealed head, by itself.

In all of the cases where this is necessary, for producing his lure with a lead-sealed head, the fisherman uses a lure of the desired size, color, shape and consistency and removes the head by breaking the bridge 22. This is easily carried out by traction. The lure then looks as shown in FIG. 6. Consequently, it is found that the body 14/tail 16 that remains, in the better embodiment according to this invention, has an anatomical shape on the transverse surface that is exposed by the removal of the head.

The fisherman can then mount his fitting 24-2 with a lead-sealed head, rigid or articulated, by making his hook penetrate as indicated above.

The anatomical shape of the contact surface between the lead-sealed head and the shape of the lead-sealed head that has a conjugated profile make it possible to ensure a perfect placing of the lead-sealed head on the body whose head has been removed. The thus equipped lure is shown in FIG. 7.

It is found that the fisherman who already has to use different lead-sealed heads, which may or may not be articulated, of different weights, complete flexible lures of different lengths, different shapes, different colors, and optionally with tails of different profiles therefore does not need to provide—in addition to complete flexible lures—lure tails that themselves also have to cover different lengths, shapes, and colors, which represents very significant fishing tackle.

The proposed cut-out 18 can also be produced by any means, in particular in several non-continuous cut-outs, such as a perforation, or by two lateral cut-outs, with the bridge actually being composed of two bridges, one in the upper part and the other in the lower part.

It is also noted that if a head has been disengaged from the body/tail of a flexible lure according to this invention, it is nevertheless possible to mount the head first and the body/tail next on a fitting.

The anatomical shape and the conjugated profile make it possible to preserve the head and the body/tail in the alignment on the fitting.

For the fittings with a simple hook, the hook shaft can bear additional and heavily marked barbs that ensure that the lure is held on said hook so well that even if the head and the body have been separated, they can be reused together.

It should also be noted that certain lead-sealed heads are equipped with an invasive end fitting that surrounds the shaft, which has retaining lugs so as to better keep the lure in place. This invasive end fitting penetrates into a portion of the body so well that the traction on the lure by the fitting is distributed between the curved part of the hook and the body of said lure.

The flexible lure according to the invention is reusable.

1. Reusable flexible fishing lure (10), comprising a head (12), a body (14), and a tail (16), characterized in that it comprises a unique and peripheral cut-out (18) forming a rupture initiator (20), at right angles to the junction of said head (12) and said body (14), with the cut-out (18) extending downward over a portion of the volume of the body (14), leaving at least one connecting bridge (22) between the head (12) and the body (14).

2. Reusable flexible fishing lure (10), according to claim 1, wherein the cut-out (18) follows a profile on the front for the parts located above and below the lure and a profile that is set back on the lateral surfaces corresponding to the gills, of anatomical shape.

3. Reusable flexible fishing lure (10), according to claim 1, wherein it comprises a fitting (24-1) in the shape of a hook (26) with a shaft (28), a tip (30), and a barb (32), with said shaft being located along the longitudinal axis of the body (14) and the tip (30) and its barb (32) projecting above and/or below the body 14.

4. Reusable flexible fishing lure (10), according to claim 1, wherein once the head is removed by traction, the body (14)/tail (16) unit receives a fitting (24-2) with a lead-sealed head.

5. Reusable flexible fishing lure (10), according to claim 2, wherein it comprises a fitting (24-1) in the shape of a hook (26) with a shaft (28), a tip (30), and a barb (32), with said shaft being located along the longitudinal axis of the body (14) and the tip (30) and its barb (32) projecting above and/or below the body 14.

6. Reusable flexible fishing lure (10), according to claim 2, wherein once the head is removed by traction, the body (14)/tail (16) unit receives a fitting (24-2) with a lead-sealed head.
